(19) United States
(12) Patent Application Publication
(10) Pub. No.: US 2008/0024274 A1
(43) Pub. Date: Jan. 31, 2008

(54) Storage System

(75) Inventors: Masato Ishida, Kyoto (JP); Yoshinori Mitta, Kyoto (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: MURATA KIKAI KABUSHIKI KAISHA, Kyoto-shi, Kyoto (JP)

(21) Appl. No.: 11/792,043

(22) PCT Filed: Dec. 1, 2005
(86) PCT No.: PCT/JP05/22071

§ 371 Date: Jun. 1, 2007

(30) Foreign Application Priority Data
Dec. 2, 2004 (JP) 2004-350206

(51) Int. Cl. B65G 1/00

(52) U.S. Cl. 340/10.1

(57) ABSTRACT

At the time of warehousing of an article, an ID tag attached to the article is read and memorized in a CPU in a manner associated with a bucket, and data and shelf address of the article are written in an ID tag of the bucket. A stacker crane reads the ID tag of the bucket and stores the bucket into the written shelf address. Management and transportation of articles stored in the warehouse can be facilitated.

### TECHNICAL FIELD

The present invention relates to a storage system including warehouses such as automatic warehouses or floor warehouses. Further, the present invention relates to a single automatic warehouse.

### BACKGROUND ART

Storage systems where articles in storage are managed based on RFID tags attached to the articles are known. For example, when an incoming shipment of articles arrives, by reading data of the RFID tags, it is possible to automatically obtain data of the incoming articles (Patent Publication 1). However, even in this approach, it is not possible to manage locations of individual articles in the storage system. By simply reading data of the ID tags of the incoming articles, though it is possible to confirm whether the articles are stored somewhere in the storage system, it is not possible to track specific positions of the articles.

Patent Publication 1: Japanese Laid-Open Patent Publication No. 2002-104632

### DISCLOSURE OF THE INVENTION

### Problems To Be Solved By the Invention

An object of the present invention is to make it is possible to track locations of individual articles in a storage system.

Another object of the present invention is to make it possible to manage positions of individual articles in an automatic warehouse.

Still another object of the present invention is to make it possible to easily check articles stored in a warehouse.

Still another object of the present invention is to make it possible to easily perform stock taking of articles.

### Means For Solving the Problems

According to the present invention, in a storage system for storing an article to which an ID tag is attached, on a carrier, an ID tag is attached to the carrier. The storage system comprises means for reading data from the ID tag of the article at the time of receiving an incoming shipment for the article, means for reading data from the ID tag of the carrier at the time of receiving the incoming shipment, and memory means for associating an ID of the carrier with an ID of the article, and storing the ID of the article, at the time of receiving the incoming shipment.

The process of associating of the ID of the carrier with the ID of the article, and storing the ID of the article herein means a process of storing data in a manner that it becomes possible to determine the ID of the article from the ID of the carrier, or it becomes possible to determine the ID of the carrier from the ID of the article.

According to another aspect of the present invention, in an automatic warehouse for storing an article to which an ID tag is attached, on a carrier, an ID tag is attached to the carrier. The automatic warehouse comprises means for reading data from the ID tag of the article at the time of storing the article in a warehouse, means for reading data from the ID tag of the carrier at the time of storing the article in the warehouse, and memory means for associating an ID of the carrier with an ID of the article, and storing the ID of the article, at the time of storing the article in the warehouse.

In the specification, the description regarding the storage system is directly applicable to the automatic warehouse, and the description regarding the automatic warehouse is directly applicable to the storage system.

The automatic warehouse system is not limited to combination of racks, stations, and transportation means such as stacker cranes. For example, the automatic warehouse may adopt a system where a plurality of racks which can be lowered/elevated are used in combination so that the articles placed on the carrier in each of the racks can be stored in, or retrieved from the warehouse.

The ID of the carrier and the ID of the article may be associated by storing the ID of the article or partially storing data of the article in the ID tag of the carrier itself. However, in this case, the storage capacity of the ID tag needs to be large. Therefore, preferably, the memory means is a control processing unit, and the control processing unit comprises means for storing externally inputted information about storage of the article in the warehouse, and means for comparing data read from the ID tag of the article at the time of storing the article in the warehouse with the externally inputted information about storage of the article in the warehouse.

Further, preferably, transportation means in the automatic warehouse has means for reading data from an ID tag of a bucket, and the transportation means moves around in the automatic warehouse to read data from the ID tag of the bucket in storage for performing stock taking.

### Advantages of the Invention

In the storage system of the present invention, since the ID of the article associated with the ID of the carrier is stored, it is possible to reliably manage the correspondence between the article and the carrier storing the article.

In the automatic warehouse according to the present invention, since the ID of the article associated with the ID of the carrier is stored, it is possible to reliably manage the correspondence between the article and the carrier storing the article.

Further, by storing externally inputted information about storage of the articles in the warehouse, and comparing data read from the ID tags of the articles at the time of storing the articles in the warehouse with the externally inputted information about storage of the articles in the warehouse, it is possible to compare the information about storage of the articles in the warehouse and the actual articles stored in the warehouse utilizing data read from the ID tags at the time of storing the articles.

### BRIEF DESCRIPTION OF THE DRAWINGS

FIG. 1 is a plan view schematically showing a layout of a storage system according to an embodiment.

FIG. 2 is a diagram showing positions of ID readers in the storage system according to the embodiment.

FIG. 3 is a diagram showing data structure of RFID tags according to the embodiment.

FIG. 4 is a view showing a layout according an embodiment including an automatic warehouse only.

FIG. 5 is a view schematically showing positions of the RFID readers in a station and a stacker crane according to the embodiment.

FIG. 6 is a flow chart showing a data processing algorithm at the time of storing articles in the warehouse according to the embodiment.

FIG. 7 is a flow chart showing a data processing algorithm at the time of performing stock taking according to the embodiment.

FIG. 8 is a flow chart showing a data processing algorithm at the time of retrieving articles from the warehouse by picking according to the embodiment.

### DESCRIPTION OF THE NUMERALS

2: storage system
4: automatic warehouse
6: automatic warehouse system
8: stacker crane
10, 11: rack
12: station
14: rail vehicle system
15: rail vehicle
16 to 20: conveyor
22: bucket magazine
24: floor warehouse
26: processing area
28: forklift
30: truck berth
32: conveyor
40 to 45: RFID reader
46: ID tag of individual package
48: ID tag of bucket
50: CPU of automatic warehouse
52: CPU of storage system
54: sub-conveyor

### BEST MODE FOR CARRYING OUT THE INVENTION

Hereinafter, an embodiment in the most preferred form for carrying out the present invention will be described.

### EMBODIMENT

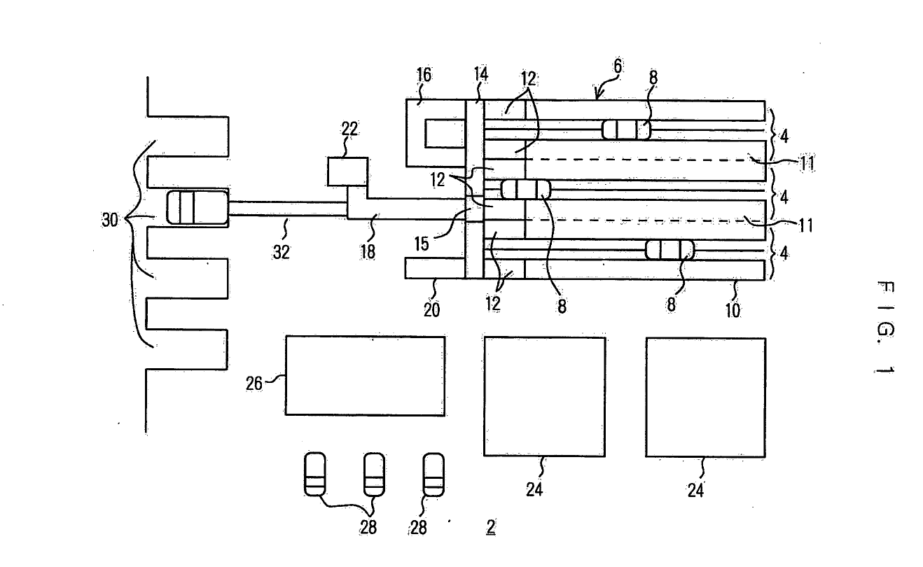

FIGS. 1 to 8 shows the embodiment. In the drawings, a reference numeral 2 denotes a storage system, and reference numerals 4 denote automatic warehouses. The automatic warehouses 4 are arranged in parallel to form an automatic warehouse system 6. In the automatic warehouse 4, stacker cranes 8 as an example of transportation means in the warehouse are provided for transporting articles between racks 10, 11, and stations for storage and retrievals of the articles. A rail vehicle system 14 is provided for the automatic warehouse system 6. A rail vehicle 15 travels between conveyors 16 to 20 and the stations 12 for transporting articles. For example the conveyor 16 is a conveyor for picking. The conveyor 16 picks articles from the bucket stored in the warehouse. After picking, the bucket is stored in the warehouse again. The conveyor 18 is a conveyor for transporting articles of incoming shipments and outgoing shipments. The conveyor 18 transports articles to/from the incoming/outgoing shipment stations such as truck berths 30. A reference numeral 22 denotes a bucket magazine. The conveyor 20 is a conveyor used by forklifts. It should be noted that the rail vehicle system 14 and the conveyors 16 to 20 may not be provided.

Reference numerals 24 denote floor warehouses. In the floor warehouses 24, no transportation apparatus or stations are provided. A reference numeral 26 denotes a processing area where articles to be transferred to the buckets are placed, and articles are picked from the buckets. Reference numerals 28 denote forklifts, reference numerals 30 denote truck berths, and a reference numeral 32 denotes a conveyor connecting the truck and the conveyor 18.

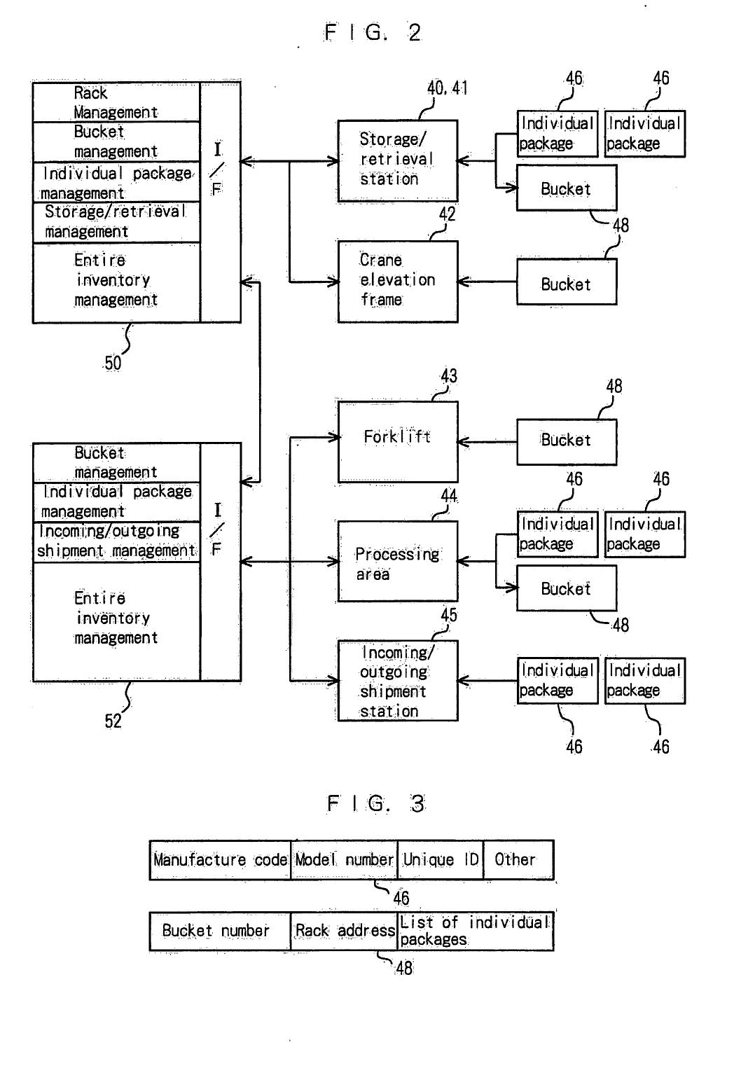

FIG. 2 shows positions of RFID readers 40 to 45. In the embodiment, RFID tags are used as ID tags. Individual articles to which the ID tags are attached are referred to as individual packages. Further, ID tags are also attached to the buckets. Instead of the buckets, ID tags may be attached to other carriers such as pallets or trays. In the specification, the ID reader may be an ID reader/writer. Reference numerals 50 and 52 denote CPUs (control processing units) of the automatic warehouse and the storage system. The CPU 52 of the storage system assigns management of the articles in the automatic warehouse system 6 to the CPU 50 of the automatic warehouse.

The RFID readers 40, 41 for the storage/retrieval station are provided in the stations 12 or the conveyors 16 to 20. The RFID reader 40 is an ID reader for reading data from ID tags 46 of the individual packages. The RFID reader 41 is an ID reader/writer for reading data in, and writing data from an ID tag 48 f the bucket. The RFID reader 42 provided in the elevation frame of the stacker crane reads data from the ID tag 48 of the bucket which is being transported by the stacker crane.

The RFID reader 43 provided in the forklift reads data from ID tag 48 of the bucket which is being transported by the forklift. The RFID reader 44 in the processing area reads data from ID tags 46 of the individual packages which are picked or packed in this area, and read data from, and write data in an ID tag 48 of the target bucket which is handled. The RFID reader 45 in the incoming/outgoing shipment station, e.g., around the truck berths reads data from ID tags 46 of the individual packages of an incoming shipment or an outgoing shipment.

The CPU 50 of the automatic warehouse has a database, and, for example, performs management of the racks, management of the buckets, management of the individual packages, management of storage of articles in, retrieval of articles from the warehouse, and management of the entire inventory of the other articles. In the rack management, empty racks and racks occupied by buckets are managed, e.g., in the units of racks addresses. In the bucket management, with respect to the ID of each bucket, the location (e.g., rack address) of the rack and the IDs of articles in the bucket are managed. Therefore, based on the ID of the bucket, a list of IDs of articles in the bucket can be obtained. In one arrangement where a fixed rack address is assigned to the ID tag of the bucket, one rack address is available to one bucket only. In another arrangement where the rack address of the bucket is a variable which can be changed each time the articles are stored in the warehouse, the number of buckets can be larger than the number of the rack addresses. The locations of the buckets are not limited to the rack addresses. The buckets may be located in other positions in the storage system, e.g., in a floor station, and by making it possible to write data of locations in the ID tags, it is possible to easily manage the positions of the buckets in the storage system.

In the storage/retrieval management, storage information regarding storage of articles in the automatic warehouse system and retrieval information regarding retrieval of articles from the automatic warehouse system, and the checking (comparison) results with the articles stored in, and retrieved from the warehouse at the station 12 is stored. The storage information or the retrieval information herein means reservation information before retrieval or storage. In the entire inventory management, other data such as inventory data of the articles in the entire automatic warehouse system is stored.

The CPU 52 of the storage system performs management of the racks, management of the buckets, management of the individual packages, management of storage of articles of the incoming shipment and the outgoing shipment, and management of the entire inventory. An interface is provided for the CPU 52 for communication with the RFID readers 43 to 45, and the CPU 50 of the automatic warehouse. Further, the CPU 52 communicates with CPUs or terminals outside the storage system 2 through the interface. The CPU 52 of the storage system assigns the management of the buckets and articles stored in the automatic warehouse system 6 to the CPU 50 of the automatic warehouse. The CPU 52 of the storage system manages buckets outside the automatic warehouse, and manages articles outside the automatic warehouse. In the bucket management, for example, positions of the buckets, IDs of the buckets, and a list of IDs articles placed in the bucket are stored. For example, when a bucket in the automatic warehouse is retrieved from the automatic warehouse, and stored in the floor warehouse, the location of the bucket is updated from a rack address in the automatic warehouse to a rack address in the floor warehouse. In the individual package management, for example, a list of individual packages is stored. In the incoming/outgoing shipment management, incoming shipment information and outgoing shipment information, and checking (comparison) results at the time of processing the incoming shipment and the outgoing shipment are stored. In the entire inventory management, other data, in particular, the inventory of the articles stored in the automatic warehouse system 6 is managed collectively. It should be noted that the process handled by the CPU 50 of the automatic warehouse and the process handled by the CPU 52 of the storage system may be handled by a single CPU.

FIG. 3 shows data of the ID tag 46 of the individual package and data of the ID tag 48 of the bucket. The ID tag 46 of the individual package stores data such as a manufacturer code, a name of an agricultural cooperative, an origin of a sample, a model number, a model type, a shipment date, and a collection date as well as a unique ID assigned to each individual package. In the case where any other data is provided, data such as a best before date, a price, a shipment destination, cautions in handling the article are stored. The ID tag 48 of the bucket stores a bucket ID as a bucket number. Further, the ID tag 48 stores a storage position such as a rack address or a storage address in the floor warehouse, and a list of individual packages placed in the bucket. The list of individual packages may be maker codes, model numbers, and the number of each model. Alternatively, the list of individual packages may be a list of unique IDs of the ID tags of the individual packages. It is at least necessary to make sure that the same IDs are not used for both of the ID tags 46 of the individual packages and the ID tags 48 of the buckets.

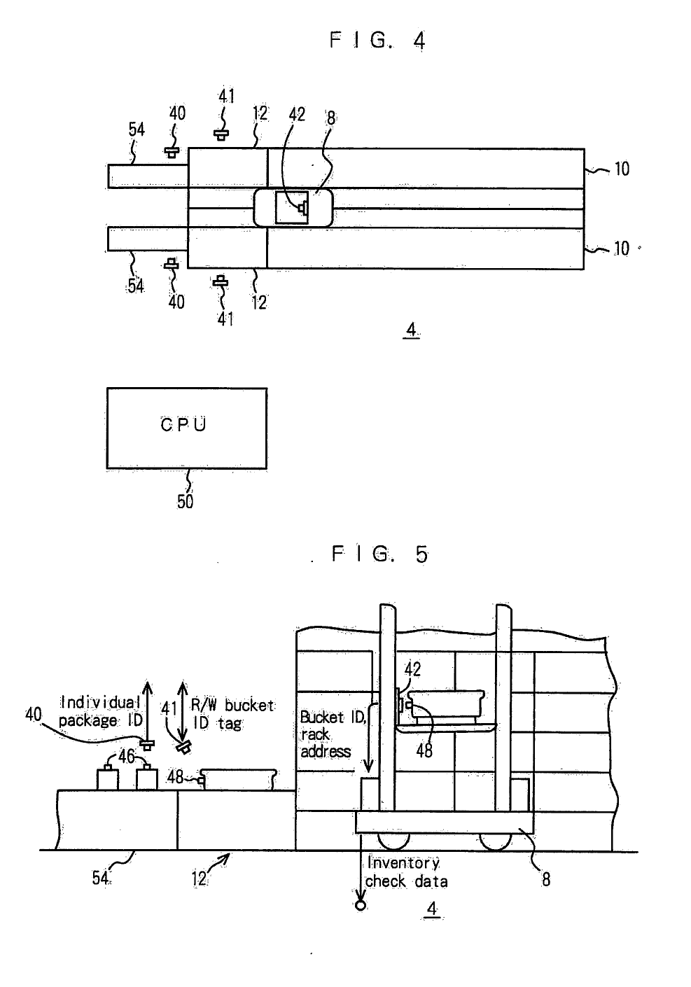

The embodiment has been described in connection with the example of the storage system 2. Alternatively, the embodiment can be carried out in the form of a single automatic warehouse 4. FIG. 4 shows an example of this case. For example, sub-conveyors 54 are connected to the stations 12. RFID readers 40 read data from ID tags of articles stored in the warehouse or ID tags of articles retrieved from the warehouse. RFID readers 41 read data of ID tag of buckets, and overwrite the data of the ID tag of each bucket using the data of, e.g., a new storage position (rack address) or a list of IDs of the individual packages placed in the bucket. The read data of the ID tags of the individual packages and the data of the ID tags of the buckets after overwriting are managed by the CPU 50 of the automatic warehouse. At this time, the ID of the bucket is associated with the IDs of the individual packages. Further, an RFID reader 42 provided at the elevation frame of the stacker crane 8 reads data of the ID tags of the buckets. Structure of the automatic warehouse 4 is equal to structure where the storage system 2 according to the embodiment is considered to be made up of only one automatic warehouse. The description about the storage system 2 is directly applicable to the automatic warehouse 4 by replacing the articles of the incoming shipment as the articles for storage in the warehouse, the incoming shipment information with the storage information, the articles of the outgoing shipment with the articles for retrieval from the warehouse, and the outgoing shipment information with the retrieval information.

FIG. 5 shows operation of reading ID tags at the time of storing articles in, and retrieving articles from the automatic warehouse 4. A reference numeral 54 denotes a sub-conveyor connected to the station 12. The RFID reader 40 reads data from the ID tags 46 of the individual packages. The RFID reader 41 reads data from the ID tag 48 of the bucket, and writes data such as a list of articles to be placed in the bucket, and a rack address for storage of the bucket, in the ID tag 48 of the bucket. These items of data are sent to the CPU 50 of the automatic warehouse, and at the time of storing the data, the ID of the bucket and the IDs of the individual packages are associated with each other.

Thus, based on the IDs of the individual packages, it is possible to determine the ID of the bucket containing the individual packages.

After the stacker crane 8 transfers the bucket, the ID tag 48 is read by the RFID reader 42 to determine the rack address as a storage destination, and the bucket is stored at the rack address. At the time of performing stock taking, the stacker crane 8 moves around along the rack. The stacker crane 8 reads a bucket number and a list of individual packages in the bucket from the ID tag of each bucket to perform the inventory check.

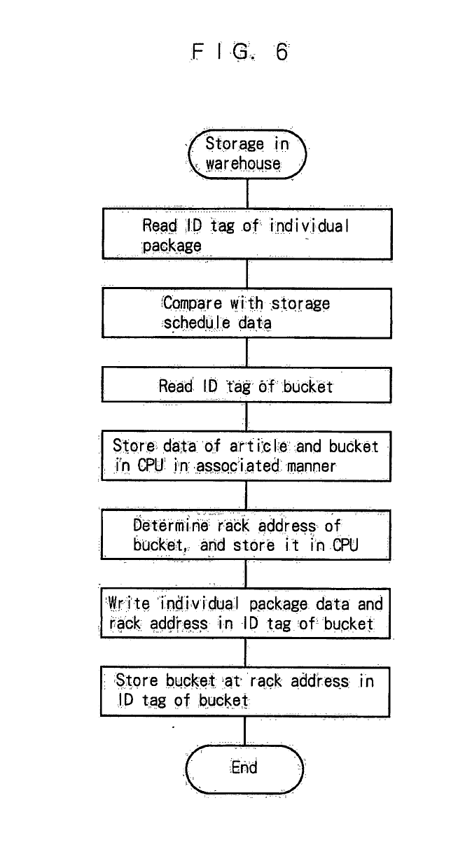

FIG. 6 shows processes at the time of storing articles in the automatic warehouse 4. The algorithm of FIG. 6 is applicable to processes at the time of receiving articles of an incoming shipment in the storage system by replacing storage of articles in the warehouse with the incoming shipment, and replacing the rack address with the storage position in the storage system. The sub-conveyor 54 reads data from the ID tags of the individual packages, and the read data is sent to the CPU 50. The CPU 50 compares the received data with data of articles scheduled to be stored in the warehouse. As a result, it is possible to inspect the articles stored in the warehouse easily. At the same time, data is read from the ID tag of the bucket, and the CPU 50 stores the data while associating the IDs of the individual packages with the ID of the bucket. Then, the rack address for storing the bucket is determined, and the data is stored in the CPU so that the locations of the individual packages can be managed in the units of buckets. The data of the individual packages and the rack address are written in the ID tag of the bucket. Then, the bucket is transferred to the stacker crane. The RFID reader at the elevation frame reads data of the rack address from the ID tag of the bucket, and the bucket is stored at the rack address. As a result, at the time of storage in the warehouse, it is not necessary to send data of the rack address for storage from the CPU 50 to the stacker crane 8.

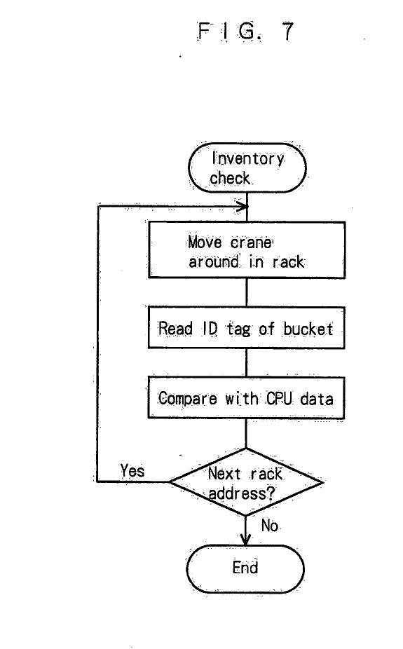

FIG. 7 shows an algorithm of processes at the time of performing stock taking. The algorithm is applicable to the entire storage system, by replacing the crane with transportation means in the storage system, and replacing the rack of the automatic warehouse with the storage position including the floor warehouse. The stacker crane moves around in the rack of the automatic warehouse to read the ID tag of the bucket at each rack address, and read a list of the individual packages stored in the bucket. The list is compared with data of the CPU. After data is read from the ID tag of the bucket at every rack address, the inventory check is completed. Therefore, the inventory check is performed easily.

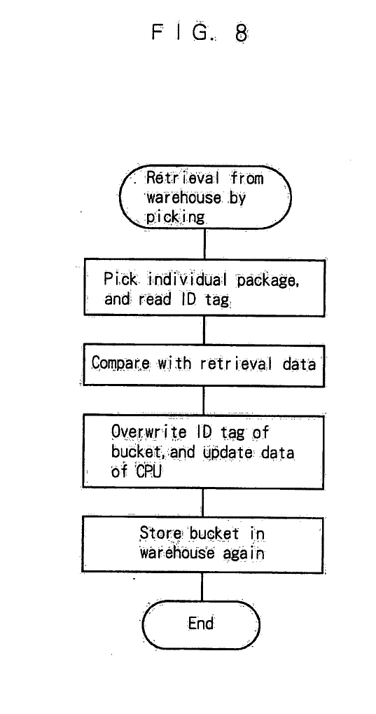

FIG. 8 shows an algorithm of processes of retrieving articles from the warehouse by picking. These process are directly applicable to the processes in the processing area 26 in FIG. 1. The bucket is retrieved to the conveyor for picking or the like. The individual packages are picked, and data is read from the ID tags of the picked individual packages. The read data is compared with data for retrieval from the warehouse for inspecting the articles at the time of retrieving articles from the warehouse. Then, the data of the ID tag of the bucket is overwritten such that data of the individual packages picked from the bucket is eliminated. The data of the CPU is updated, and the bucket is stored in the warehouse again.

In the embodiment, the bucket is used as the carrier. Alternatively, a pallet or a tray may be used as the carrier. Further, in the embodiment, data of the individual packages is written in the ID tag of the bucket. In the case where the storage capacity of the ID tag is not sufficient, the bucket and the individual packages are only associated by the CPUs 50 and 52. In this case, in the inventory check by reading data from the ID tag of the bucket, it is sufficient to actually confirm the ID of the bucket, and the individual packages are not confirmed actually.

1. A storage system storing articles with ID tags on a carrier being characterized in that
said carrier is provided with another ID tag;
that a transportation apparatus for storage of the storage system is provided with means for reading data in the ID tags of the articles and means for reading data in the ID tag of the carrier; and
that a memory means for storing ID data of the articles in such a way that the data read from the ID tags of the articles is associated with ID of the carrier.

2. An automatic warehouse storing articles with ID tags on a carrier being characterized in that
said carrier is provided with another ID tag;
that a transportation apparatus for storage of the automatic warehouse is provided with means for reading data in the ID tags of the articles and means for reading data in the ID tag of the carrier; and
that a memory means for storing ID data of the articles in such a way that the data read from the ID tags of the articles is associated with ID of the carrier.

3. The automatic warehouse being characterized in that said memory means is provided in a control processing unit of the automatic warehouse and that the control processing unit is provided with means for storing storage information of the articles inputted from an outside data source and means for comparing the data read from the ID tags of the articles when being stored and said storage information for inspection.

4. The automatic warehouse of claim 2 being characterized in that said carrier is a bucket with said another ID tag and that a transportation apparatus for transporting said bucket in the automatic warehouse is provided with means for reading data in said another ID tag of the bucket and that stock taking of the automatic warehouse is performed with reading data in said another ID tag of the bucket, while making said transportation apparatus for transporting said bucket in the automatic apparatus traveling in the automatic warehouse.

5. The automatic warehouse of claim 2 being characterized in that the transportation apparatus for storage comprising a storage station and a conveyor connected to the station, that said means for reading data in the ID tags of the articles is provided in the vicinity of the conveyor, and that said means for reading data in the ID tag of the carrier is provided for said storage station.
